(19) United States
(12) Patent Application Publication
(10) Pub. No.: US 2009/0067052 A1
(43) Pub. Date: Mar. 12, 2009

(54) Optical apparatus

(76) Inventor: Markus Seesselberg, Aalen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/228,963

(22) Filed: Aug. 18, 2008

(30) Foreign Application Priority Data
Aug. 17, 2007 (DE) 102007038946.0
Sep. 17, 2007 (DE) 102007044228.0

(51) Int. Cl. G02B 27/44

(52) U.S. Cl. 359/571; 359/569

(57) ABSTRACT

An optical apparatus (10) is described, having at least one objective element (20) which has two or more objective lens elements (21, 24, 27), wherein one of the objective lens elements (21) is designed as a support lens element for a diffractive optical element (15), the support lens element having a diffractive optical element (15). In order to create an optical apparatus (10), with which a particularly good correction of the chromatic magnification difference can be achieved, it is provided that the optical apparatus (10) is designed as a Galileo system or as a Kepler system, that the optical apparatus (10) has an ocular element (30) with at least one ocular lens element (31), that the diffractive optical element (15) is disposed in the optical apparatus (10) or designed in such a way that the light rays impinge on it at an angle of less than 20 degrees and that the diffractive optical element (15) has a minimum groove width h of more than 50 μm, in particular, of more than 100 μm.

The present invention relates to an optical apparatus, in particular, a telescopic apparatus, with at least one objective element, wherein the objective element has two or more objective lens elements.

This type of optical apparatus can be, for example, a so-called Galileo system.

Galileo systems are suitable, for example, for constructing short telescopes. If the eye observes through such a Galileo telescope, then it sees an upright image with correct [right and left] sides. The arrangement of two Galileo telescopes for the two eyes is thus the rule. If such Galileo telescopes are used as binoculars, such as, for example, for use in the theater or similar purpose, the object plane lies in infinity or at least far distant from the front lens (typically more than 10 meters). In this case, one speaks of “Galileo binoculars”. It may also be desirable, however, to place the object plane closer to the front lens of the Galileo telescope, so that the distance amounts to between 20 cm and 100 cm, for example. Thus, one obtains a type of magnifying lens having a large distance to the object. In this case, one speaks of a “Galileo magnifying lens”, i.e., “Galileo magnifying glasses”. Galileo magnifying glasses are frequently used by people with impaired eyesight as magnifying glasses. Galileo magnifying glasses, however, are also used professionally, for example, by dentists, dental assistants, precision mechanical technicians, jewelers, and in similar fields.

A Galileo system generally consists of an objective element with positive refractive power, as well as an ocular or eyepiece element with negative refractive power. Here, both the objective and the eyepiece may consist of one or more lens elements. The diameter of the objective is advantageously larger, preferably distinctly larger than the diameter of the eyepiece, so that the weight of the objective lens is clearly greater than the weight of the ocular lens.

Thus, Galileo systems, for example Galileo telescopes, can be used comfortably if they are light in weight, have a short structural length and a viewing field that is not too small. Weight and structural length particularly play a very large role in the case of magnifying glasses, since these are mostly worn on the head and for this purpose are often mounted in a type of frame for glasses.

New variants of Galileo telescopes are continually being developed and have been for a long time. An important design parameter of a Galileo telescope is the magnification. As a rule of thumb, it can be assumed that the number of lenses in a Galileo telescope increases with the magnification. Thus, a Galileo system having three lenses is proposed in U.S. Pat. No. 5,463,500 B. In U.S. Pat. No. 5,790,323, a Galileo system with higher magnification is presented, which already contains five lenses.

In DE 10 2005 036 486 A1, an optical device is described, with which an increased depth of field should be achieved. For this purpose, a device for increasing the depth of field is provided, which involves, for example, a diffractive optical element. This device for the depth of field is disposed between an objective element and an ocular element. The diffractive optical element utilized in this known solution is used for a very specific purpose. It does not operate to correct chromatic imaging errors, but rather it provides an optical element with several focal points. In principle, this optical device operates with a diffractive optical element, since with such an element, the light can be simultaneously diffracted into different diffraction orders, which leads to different focal points.

In the case of Galileo magnifying glasses, however, this effect is undesired. Also, in the case of Galileo binoculars, an important quality feature therein is the correction of the chromatic magnification difference. The latter generally involves imaging errors that arise due to the wavelength dependence of the refractive index. Since Galileo binoculars and magnifying lenses are usually used in the visible spectrum, they are broadband optical systems. If the chromatic magnification difference is not well corrected, then color “fringing” occurs, which is then perceived as disturbing. This is based on the fact that a somewhat different imaging scale factor is usually associated with each wavelength, so that the images that form on a detector have a somewhat different size, depending on their color. This effect is perceived as color fringes. Such color fringes are very disturbing and are very rapidly conspicuous to a user. Such color fringes are particularly to be avoided in professional applications of Galileo systems.

In DE 298 23 076 U1, an optical system is described for binoculars or magnifying glasses, wherein the optical system has a one-piece objective lens. Here, the surface of the objective lens which is turned toward an eyepiece lens has a diffractive structure. It is already possible in this way to correct to a limited extent the chromatic magnification difference.

Proceeding from the named prior art, the object of the present invention is to further develop an optical apparatus of the type named initially, so that the disadvantages described for the prior art can be avoided. In particular, an optical apparatus will be created with which the correction of the chromatic magnification difference can be further improved relative to the solution described in DE 298 23 076 U1.

This object is achieved according to the invention by the optical apparatus with the features according to the independent patent claim 1. A particular use of such an optical apparatus is indicated in independent patent claim 12. Additional features and details of the invention derive from the subclaims, the description and the drawings.

According to the invention, an optical apparatus, in particular, a telescopic apparatus is provided, with at least one objective element which has two or more objective lens elements, wherein one of the objective lens elements is designed as a support lens element for a diffractive optical element, this support lens element having a diffractive optical element. The optical apparatus is characterized in that it is formed as a Galileo system or as a Kepler system, that it has an ocular element with at least one ocular lens element, that the diffractive optical element is disposed in the optical apparatus or designed in such a way that the light rays impinge on it at an angle of less than 20 degrees and that the diffractive optical element has a minimum groove width h of more than 50 μm, in particular, of more than 100 μm.

In its general configuration, an optical apparatus, in particular, a telescopic apparatus is provided, having at least one objective element which has two or more objective lens elements. The optical apparatus is hereby characterized in that one of the objective lens elements is designed as a support lens element for a diffractive optical element, this support lens element having a diffractive optical element.

The present invention is basically not limited to specific types of optical apparatuses or functionalities of optical apparatuses. However, it particularly involves a telescopic apparatus, wherein the invention is also in this respect not limited to specific types of telescope. Several advantageous, but non-exclusive examples of optical apparatuses will be explained in more detail in the further course of the description.

The optical apparatus can be formed advantageously as an apparatus of the Galileo type, i.e., as a Galileo system. Galileo systems basically consist of an objective element with positive refractive power and an ocular element with negative refractive power. In this case, both the objective as well as the eyepiece may consist of one or more lenses. The diameter of the objective is usually clearly larger than the diameter of the eyepiece. Galileo systems have already been known for a long time and are familiar to persons skilled in the art working in this field.

In another configuration, it can also be provided that the optical apparatus is formed as a Kepler system. Kepler systems are usually telescopes in the form of lens telescopes that have a convergent objective lens and a convergent eyepiece lens. Kepler systems have already been known for a long time and are familiar to persons skilled in the art working in this field. They are frequently used as astronomical telescopes. With a suitable device for image reversal, for example, with appropriate prisms, Kepler systems also find use, however, as terrestrial binoculars.

In another configuration, it can be provided that the optical apparatus has an ocular or eyepiece element. This ocular element in turn has at least one ocular lens element. Here, the invention is neither limited to a specific number, nor to specific forms of ocular lens elements. Several advantageous, but non-exclusive examples of suitable ocular lens elements will be described in the further course [of the description].

The optical apparatus has at least one objective element as a fundamental feature. In its turn, the objective element has two or more objective lens elements. Here, of course, the invention is not limited to a specific number of objective lens elements.

One of the objective lens elements is formed as a support lens element for a diffractive optical element. This support lens element also has a diffractive optical element. “To have” means here that the diffractive optical element is disposed on or at the support lens element. “To have” can also mean, however, that the diffractive optical element is designed on or at or in the support lens element. Of course, in this respect, combinations are also conceivable. The support lens element preferably has at least one support surface, on/at which the diffractive optical element is disposed, or on/at/in which the diffractive optical element is found. The disposition of the diffractive optical element or its design on/at/in the support lens element thus results from its configuration, so that in this respect, as is also the case relating to the configuration of the diffractive optical element, the invention is not subject to limitation. Several advantageous, but non-exclusive examples of this will be explained in more detail in the further course of the description.

A diffractive optical element is generally an optical element, for example, a pattern—sometimes complex—of structures, for example of microstructures, which can modulate and transform light in a defined manner. For example, a diffractive optical element may involve an optical surface provided with structures which provide optically active functions at these structures by the diffraction of light.

It can be provided, for example, that the support surface for the diffractive optical element is formed as a planar surface, so that the diffractive optical element lies on a planar surface. Of course, the diffractive optical element can also lie on a curved surface or a surface that is at least curved in regions.

The objective element has a diffractive optical element according to the invention. Diffractive optical elements have the property of also deflecting a certain amount of light continuously into undesired orders of diffraction. This leads to double images or to a reduction in contrast. Thus it is advantageous to utilize only one diffractive optical element, and not several diffractive optical elements, in an optics system. A solution with several diffractive elements is therefore to be viewed as disadvantageous.

The diffractive optical element, which is used in the optical apparatus according to the invention, is advantageously configured in such a way that as much of the light as possible is deflected into the useful order. As little light as possible will be deflected into other diffraction orders.

It is advantageously provided that the diffractive optical element is disposed in the optical apparatus or designed in such a way that light rays impinge on it at an angle of less than 20 degrees. The light rays preferably impinge on the diffractive optical element at an angle of less than 10 degrees. The light rays most preferably impinge on the diffractive optical element approximately perpendicularly. It is advantageous if the light rays impinge as much as possible perpendicularly onto the support surface of the diffractive optical element. That is, the smaller the angle of incidence is on the support surface of the diffractive optical element, the less false light arises in undesired diffraction orders.

Preferably, the diffractive optical element has a minimum groove width h of more than 50 μm, in particular, of more than 100 μm. It is advantageous if the minimum groove width h of the diffractive optical element is not too small. Minimum groove widths of h>50 μm are favorable, [and] minimum groove widths of h>100 μm are preferred. That is, the smaller the minimum groove width h is, the more false light arises in undesired diffraction orders, if the sides of the diffractive optical element do not run parallel to the optical axis of the lens. Thus, due to manufacturing defects of diffractive optical elements made of plastic, a diffractive optical element will deflect less light in undesired diffraction orders the larger the groove width is. For example, it may be the case that the groove width decreases toward the edge of the diffractive optical element. In such a case, the minimum groove widths are then found in the edge region of the diffractive optical element.

In the simplest case, the objective element has two objective lens elements, wherein one of the objective lens elements is designed as a support lens element for the diffractive optical element. It may also be advantageously provided, however, that the objective element has two or more objective lens elements, wherein also in this case, one of the objective lens elements is designed as a support lens element for the diffractive optical element. Preferably, the objective element can have three objective lens elements.

The individual objective lens elements can be designed, for example, as individual lenses. In this case, at least one of the objective lens elements has a diffractive optical element. It is also possible, however, that at least one of the objective lens elements is formed as a cemented member, wherein the cemented member is comprised of at least two lens elements. Likewise, configurations are conceivable, in which the two or more objective lens elements of the objective element are designed in the form of a single cemented member. In such a case, the two or more objective lens elements then form the individual lens elements of the cemented member. If the objective element has three or more objective lens elements, it may be provided that at least two objective lens elements are formed as a cemented member, and that at least one other objective lens element is formed as an individual lens.

Insofar as at least one objective lens element is formed as a cemented member in the above-named form, at least one diffractive optical element can be designed/disposed, for example, on one of the outer surfaces of the cemented member. In this case, the diffractive optical element is found on/at one of the surfaces of the cemented member.

Alternatively or additionally, it can also be provided that at least one diffractive optical element is designed/disposed on one of the lens surfaces provided inside the cemented member. In this case, the diffractive optical element is found on/at one of the lens inside surfaces of the lenses of the cemented member; it is thus “buried” in the cemented member. Such types of diffractive optical elements are described, for example, in U.S. Pat. No. 5,734,502 or EP 0 965864 A2, whose disclosure content is incorporated to this extent in the description of the present invention.

An optical apparatus, which has the following advantages, among others, is provided according to the present invention: With a suitable selection of lens elements, at least some of which may be advantageously comprised of plastic, as will be described in more detail below, an optical apparatus light in weight can be provided. This is of advantage, for example, if the optical apparatus will be worn on the head. In addition, the optical apparatus also can be produced in a cost-effective way, in particular, if plastic components are used. Such plastic components can be manufactured in a cost-effective way, for example, by means of an injection molding process.

Finally, a good correction state—in particular with a small number of lenses—can be achieved by means of the optical apparatus. This is achieved, since the objective element has, in addition to the objective lens element with the diffractive optical element, at least one additional objective lens element—as has already been disclosed in the above-named DE 298 23 076 U1. In this way, in particular, the correction of the chromatic magnification difference can be further improved. It is particularly preferred if the objective element has three objective lens elements. Of course, the invention is not limited to a specific number and configuration of objective lens elements. Several advantageous, but non-exclusive embodiment examples will be explained in more detail in the further course of the description.

Advantageously, at least one objective lens element, which is not designed as a support lens element for the diffractive optical element, can be designed as a refractive lens element. One lens element or one lens surface can then operate refractively if the imaging of the light rays is based exclusively on the law of refraction. A diffractive optical element does not operate refractively. Usually, “conventional” convergent or divergent lenses are refractively operating lenses. The use of refractive lens elements leads to another improvement in correction, in particular, to further improved correction of the chromatic magnification difference, and in fact preferably with a smaller number of lenses. It can be advantageously provided that one lens element (the support lens element) with a diffractive optical element is used in the objective element of the optical apparatus, and that all other optical elements of the objective element—optionally also another ocular element which will be explained in detail below—are refractive.

It is preferably provided that at least one lens surface of at least one objective lens element is designed as an aspherical surface. In this case, the aspherical surface can be positioned basically anywhere in the objective element. For example, the aspherical surface may involve a surface subsequent to the lens surface having the diffractive optical element. It is, of course, also conceivable that the support surface of the diffractive optical element is itself an aspherical surface. Two or more aspherical surfaces may also be provided and utilized.

In another configuration, it is advantageously provided that the objective lens element designed as a support lens element for the diffractive optical element and/or at least one objective lens element not designed as the support lens element for the diffractive optical element is/are formed of plastic. Such lens elements, which are not formed of plastic, can be advantageously formed of glass. It is advantageously provided that both the support lens of the diffractive optical element as well as at least one other objective lens element are comprised of plastic. The more plastic lenses that can be used, the greater is the obtainable savings in weight of the optical apparatus.

In an advantageous embodiment, it can be provided that the objective element is comprised of two plastic lens elements and one glass lens element. An optionally provided ocular element of the optical apparatus can consist of plastic or glass. It is possible, however, by changing the lenses, to adapt the optical apparatus, for example, Galileo magnifying glasses, to different object distances, wherein the magnification is kept constant. Thus, cost-effective optical apparatuses can be produced for different object distances. For adaptation to a desired object distance, however, one can also vary the distance between objective and eyepiece, so that, for example, Galileo binoculars with different object distances can be constructed with the lens elements.

The invention is not limited to the use of specific materials for the lens elements. Several advantageous, but non-exclusive examples of suitable materials will be indicated further below in connection with the examples.

It can advantageously be provided that a glass lens element in the objective element is extensively modified, that the glass lens is replaced in the objective by a plastic lens, for example, consisting of the material Ultem produced by GE Plastics. Therefore, a further reduction in weight can be achieved, since the heaviest glass lens of the system will thus be replaced by plastic. The Ultem lens can also be cemented with a Zeonex lens, which presents further advantages, such as a simplified mounting technique, coarser surface tolerances, fewer coatings and similar advantages.

As was discussed further above, the diffractive optical element can be configured in different ways, so that the invention is not limited to a concrete configuration in this respect. Several advantageous, but non-exclusive configurations of a diffractive optical element will be explained in the following.

For example, a diffractive optical element can be comprised of a surface relief in the lens material at the air interface, this relief reaching the highest diffraction efficiency, for example, in the green at λ≈550 nm according to scalar theory, whereas the diffraction efficiency decreases to around 80% at the blue and red edges of the spectrum. Therefore, each diffractive optical element causes false light from undesired diffraction orders, which leads to the formation of double images and to a loss of contrast. Thus, the use of more than one diffractive optical element is critical.

For example, it can be provided that the diffractive optical element is designed or disposed as an annular system on the support surface of the support lens element. The support lens element here may be comprised of plastic or glass. As the material for the support lens element, for example, a pressed or molded glass with a low glass transition temperature Tg can be used, so that the support lens element plus the diffractive optical element can be blank pressed. For example, it may also be provided that the diffractive optical element is replicated as an annular plastic system on the surface of a glass lens.

Advantageously, the diffractive optical element can be designed step-shaped. This means that the diffractive optical element has a step-shaped course in such a case.

The objective element of the optical apparatus, for example, magnifying glasses, can thus also have, in addition to the diffractive optical element for color correction, a glass divergent lens, which consists of SNPH 2, for example, and has a particularly low Abbé coefficient η_{d}=18.9, which brings about a portion of the color correction refractively. The diffractive optical element then preferably has a minimum groove width h of approximately 110 μm. This minimum groove width h is larger than in the previously known solutions.

The diffractive optical element can preferably be disposed or designed on a support surface of the support lens element, wherein the support surface consists of a fundamental spherical shape. This advantageously can involve a so-called kinoform, which consists of a fundamental spherical shape with superimposed diffractive optical element. It is also conceivable, of course, that the diffractive optical element is found on a fundamental aspherical shape.

The diffractive optical element can advantageously be disposed inside the objective element. It is advantageous if the diffractive surface lies inside the optical apparatus, and not on the front surface. The reason for this is that dirt or other contaminants cannot settle on the diffractive optical element and the system is thus easier to clean.

For example, at least one ocular or eyepiece lens element, as mentioned further above, can be formed as a cemented member from at least two lens elements. The chromatic magnification difference can be still better corrected, for example, if the ocular lens is replaced by a cemented member comprised of two glass lenses. This cemented member, however, may also consist of two different plastics, for example, Zeonex and polycarbonate.

In another configuration, at least one ocular lens element can be formed as a lens element with variable focal length. For example, a variable lens whose focal length can be varied electrically or in another way could be used in the eyepiece, for example, in the form of a liquid lens or the like. Lenses with variable focal length have already been known for some time. Employing this type of lens, individual refractive error can be compensated for and the distance to the object can be made adjustable without mechanically moved parts. If one now takes a liquid lens that represents a cylinder lens, the astigmatism of the user of the proposed optical apparatus, special glasses for example, can also be corrected. The variable lens element may also be designed in the form of a variable cylinder lens. Then, for example, a person with astigmatism who wears glasses could well utilize the optical apparatus, in particular, if it is magnifying glasses.

An optical apparatus according to the present invention, which can be designed, for example, as a Galileo system or as a Kepler system can advantageously be designed as a magnifying apparatus or as a binocular apparatus or as a telescopic apparatus or as a liquid lens with a toroidal surface. In this case, of course, the invention is not limited to the named configurations. Suitable applications for Galileo telescopes are, for example, moderately priced night glasses (Galileo systems have a large exit pupil), Galileo systems in microscopes, for example, operating microscopes, and the like. Magnifying apparatuses may be created, for example, in the form of magnifying glasses, which can be utilized, for example, by dentists, dental assistants, precision mechanics technicians, and in similar professions.

An optical apparatus according to the invention may advantageously be used as a magnifying apparatus, in particular, in magnifying glasses, or as field glasses, or as a small telescope, or as a liquid lens with a toroidal surface.

An optical apparatus according to the present invention can advantageously be designed as a Galileo system or as a Kepler system with diffractive optical element.

In diffractive optical elements, the scalar diffraction efficiency for red and blue light decreases to values of approximately 80%, so that false light from undesired diffraction orders appears at the edges of the spectrum and this leads to a decrease in contrast or to the formation of colored double images. If one changes the construction of the diffractive optical element, and in this case, if one uses very different types of materials that are precisely matched to one another, the diffraction efficiency can be clearly increased over the entire wavelength band. This procedure is described, for example, in the patents U.S. Pat. No. 5,734,502 or EP 0 965 864 A2, whose disclosure content is incorporated to this extent in the description of the present invention.

The invention will now be explained in detail on the basis of several examples with reference to the appended drawings. Here

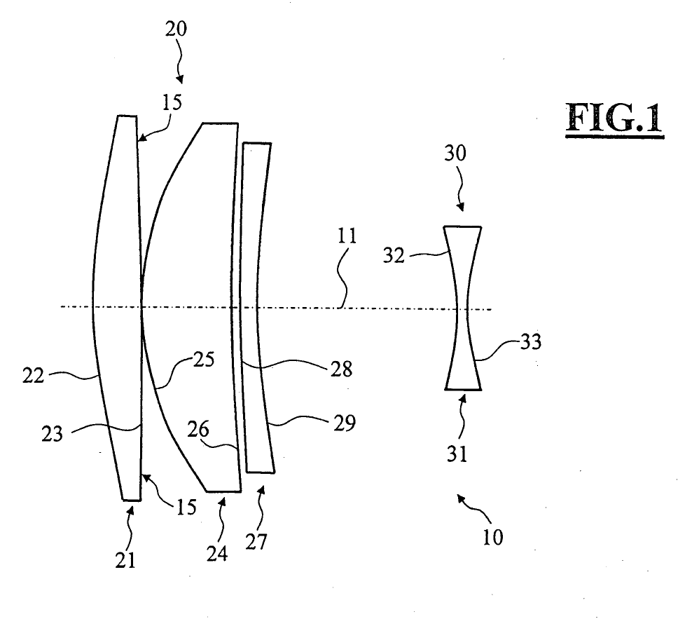

FIG. 1 shows an optical apparatus according to the present invention;

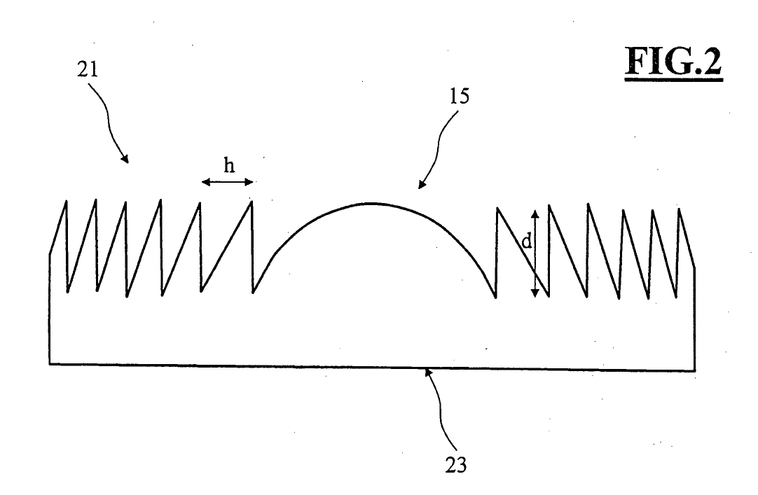

FIG. 2 shows an example of embodiment for a diffractive optical element; and

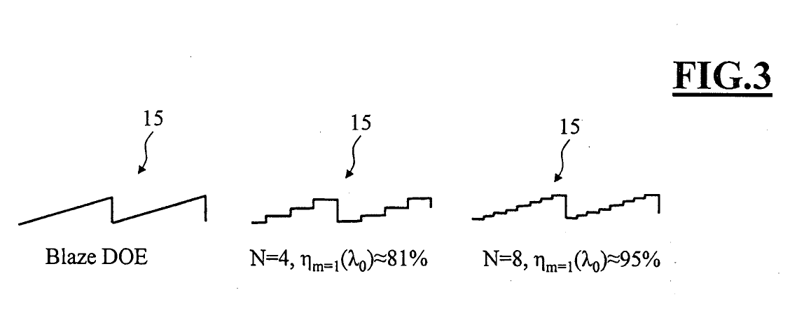

FIG. 3 shows various structures of other embodiment examples for a diffractive optical element.

The optical apparatus 10 according to FIG. 1 is constructed in the form of a Galileo system and consists of an objective element 20 and an ocular element 30, which are disposed along an optical axis 11. The optical apparatus 10 can be designed, for example, as a magnifying apparatus and can be a component of magnifying glasses as such.

The ocular element 30 in the example shown consists of an ocular lens element 31, which has two lens surfaces 32, 33. The ocular lens element 31 can be manufactured from glass, for example. A glass with an Abbe coefficient that is as small as possible is preferably used in this case in order to minimize chromatic error. The ocular lens element 31, however, could also be comprised of plastic.

The objective element 20 in the example shown consists of three objective lens elements 21, 24, 27. The objective lens element 21 is a support lens element for a diffractive optical element 15, which is disposed or designed on a support surface 23 of the support lens element 21. In the example shown, the diffractive optical element 15 lies on a surface which is directed toward the inside of the objective element 20, and not on its front surface 22. The support lens element 21 is advantageously formed of plastic. In the example shown, this is the front lens of the objective element 20.

In addition, the objective element 20 has two other objective lens elements 24, 27, each of which provides lens surfaces 25, 26 (lens element 24) or 28, 29 (lens element 27). At least one of these lens elements 24, 27 is made of plastic. The other lens element can then be produced from glass. Of course, it is also conceivable that all of the lens elements 21, 24, 27 of the objective element 20 are comprised of plastic.

In the example shown, the following are seen from the left: the first three lenses 21, 24, 27 with the lens surfaces 22, 23, 25, 26, 28, 29 [forming] the objective 20; the lens 31 with the lens surfaces 32 and 33 is the ocular element or eyepiece. The object is found to the left of lens surface 22, the observer's eye is found to the right of lens surfaces 33. The lens surface 23 is the support surface of the diffractive optical element 15. The lens surface 25 is an aspherical surface. The lens material of the first two lenses 21, 24 from lens surface 22 to lens surface 26 is plastic.

A section through the objective lens element 21, which represents the support lens element for the diffractive optical element 15, is shown in more detail in FIG. 2. The diffractive optical element 15 is designed on lens surface 23 of lens element 21, so that lens surface 23 represents the support surface for the diffractive optical element 15. In FIG. 2, care was taken that the aspect ratio was changed in such a way that the diffractive optical element 15 is shown as well visible as possible. Actually, the groove depth d is typically clearly smaller than the groove width h. The diffractive optical element 15 lies on a planar surface in FIG. 2. Of course, the diffractive optical element 15 can also lie on a curved surface. The structure shown in FIG. 2 is also designated as a “kinoform”.

Of course, the structure can also be “binarized”. A diffractive optical element 15 is then obtained with a step-shaped course. In this respect, three different embodiments are shown in FIG. 3, where a stepped course is shown therein for each of two rings of the diffractive optical element 15.

In the following, different examples are described, which are based on the above-described optical apparatus 10, wherein different object distances have been selected each time.

### EXAMPLE 1

### Object Distance of 351 mm

In this example, Galileo magnifying glasses with an object distance of 351 mm between the object and front lens 21 are given. In this case, the system is designed so that the virtual image appears to lie approximately 1 m in front of the observer. The virtual image, however, could also lie in infinity. The figure shows the lens segment of the Galileo telescope according to the invention, whose structure is described in Table 1.

In Table 1, and likewise in the following Tables 2 and 3, the surface number 1 corresponds to lens surface 22, the surface number 2 corresponds to lens surface 23, the surface number 3 corresponds to lens surface 25, the surface number 4 corresponds to lens surface 26, the surface number 5 corresponds to lens surface 28, the surface number 6 corresponds to lens surface 29, the surface number 7 corresponds to lens surface 32 and the surface number 8 corresponds to lens surface 33.

TABLE 1

| | | Thickness or | Glass or | Free diameter |
|---|---|---|---|---|
| No. | Radius [mm] | air gap [mm] | medium | [mm] |
| 0 | | 351.0 | air | |
| 1 | 50.0 | 3.6 | Zeonex E48R | 28.5 |
| 2 | −453.490945 | 0.1 | air | 28.5 |
| 3 | Aspherical | 6.9 | Zeonex E48R | 27.3 |
| | surface | | | |
| 4 | 190.322518 | 0.6 | air | 27.3 |
| 5 | 244.870247 | 1.3 | Ohara SNPH2 | 24.5 |
| 6 | 65.189864 | 15.371 | air | 24.5 |
| 7 | −18.916447 | 0.8 | Schott | 12.4 |
| | | | NPK52A | |
| 8 | 22.196810 | | air | 12.4 |

The diffractive optical element 15 lies on lens surface 23 (surface number 2), which represents the support surface of support lens element 21, which simultaneously also forms the front lens of the objective element 20. Here, this involves a so-called kinoform, which consists of a fundamental spherical form with a superimposed diffractive optical element. The z-axis of this surface points away from the Zeonex E48R. The surface is rotationally symmetric and can thus be described by a camber height zₜₒₜₐₗ(h), which is comprised of a spherical component zₛₚₕ(h) and a component z_{doe}(h) of the diffractive optical element (DOE) according to

$$\begin{matrix}{z}_{total} ( h ) = {z}_{sph} ( h ) + {z}_{doe} ( h ) with {w}_{sph} \\ = \frac{{h}^{2} / R}{1 + \sqrt{1 - {h}^{2} / {R}^{2}}}\end{matrix}$$

The spherical component zₛₚₕ(h) corresponds to a sphere with a radius of curvature of R=−453.490945 mm. The DOE component z_{doe}(h) is calculated from the equations

$${z}_{doe} ( h ) = - d \cdot {n}_{doe} ( h ) + d \cdot INT ( {n}_{doe} ( h ) )$$

$$d = \frac{{λ}_{0}}{n ( {λ}_{0} ) - 1}$$

$${n}_{doe} ( h ) = \frac{{e}_{doe} {h}^{2}}{2} + {c}_{1} \cdot {h}^{4} + {c}_{2} \cdot {h}^{6} + {c}_{3} \cdot {h}^{8} + {c}_{4} + {h}^{10} .$$

In Galileo magnifying glasses, one would like to have a diffractive optical element 15 (DOE), in which all light, insofar as possible, is deflected plus or minus into the useful order. As little light as possible shall be deflected into other diffraction orders. For this reason, the DOE depth d is given according to the above-given equation, from which it results that as much light as possible is deflected into the useful order with an amount of one.

In the above-given equations, INT(x) designates the whole-number component of x, for example, INT(5.8)=5. The constants have the following values:

ρ_{doe}=0.395218 mm⁻²

c₁=0.25569131·10⁻² mm⁻⁴

c₂=−0.20661187·10⁻⁴mm⁻⁶

c₃=0.69386672·10⁻⁷ mm⁻⁸

c₄=−0.82035357·10⁻¹⁰ mm⁻¹⁰

λ₀=550 nm

η(λ₀)=1.53202172

The groove width of the diffractive optical element 15 decreases to the edge of the lens and there amounts to approximately 110 μm. The lens surface 25 (surface number 3) of lens element 24 is an aspherical surface, whose camber height zₐₛₚₕ can be described as a function of the radius h according to

$${z}_{asph} ( h ) = \frac{ρ {h}^{2}}{1 + \sqrt{1 - {ρ}^{2} {h}^{2}}} + {c}_{1} \cdot {h}^{4} + {c}_{2} \cdot {h}^{6} + {c}_{3} \cdot {h}^{8} + {c}_{4} \cdot {h}^{10}$$

ρ=(22.43533 mm)⁻¹

c₁=0.12463015·10⁻⁶ mm⁻³

c₂=0.29057077·10⁻⁷ mm⁻⁵

c₃=−0.55128472·10⁻¹⁰ mm⁻⁷

c₄=0.17274067·10⁻¹² mm⁻⁹

According to the figure, the objective 20 of this example of embodiment of a Galileo telescope according to the invention comprises three lenses 21, 24, 27 with the lens surfaces 22, 23, 25, 26, 28, 29 (surface numbers 1 to 6). Of these three lenses 21, 24, 27, two lenses are comprised of plastic, advantageously the two lenses 21 and 24. The diffractive optical element 15 lies on the back side of front lens 21 on lens surface 23 (surface number 2). The ocular or eyepiece element 30 consists of a lens 31 with lens surfaces 32 and 33 (surface numbers 7 and 8).

### EXAMPLE 2

### Object Distance of 251 mm

In this example, Galileo magnifying glasses are given with an object distance of 251 mm between the object and front lens 21. Table 2 contains a description of the example of embodiment for a Galileo telescope according to the invention with an object distance of 251 mm. The data for lens surfaces 22, 23, 25, 26 (surface numbers 1 to 4 in Table 2), including diffractive element 15, which are, in particular, the diffractive optical element 15 as well as the aspherical surface, have the same data as given in Example 1 for the object distance of 351 mm.

TABLE 2

| | | Thickness or | Glass or | Free diameter |
|---|---|---|---|---|
| No. | Radius [mm] | air gap [mm] | medium | [mm] |
| 0 | | 251.0 | air | |
| 1-4 | see Table 1 | | | |
| 5 | 182.790865 | 1.3 | Ohara SNPH2 | 24.5 |
| 6 | 58.854162 | 15.7 | air | 24.5 |
| 7 | −17.299091 | 0.8 | Schott | 12.4 |
| | | | NPK52A | |
| 8 | 33.484685 | | air | 12.4 |

### EXAMPLE 3

### Object Distance of 501 mm

In this example, Galileo magnifying glasses are given with an object distance of 501 mm between the object and front lens 21. Table 3 contains a description of the example of embodiment for a Galileo telescope according to the invention with an object distance of 501 mm. The data for lens surfaces 22, 23, 25, 26 (surface numbers 1 to 4 in Table 3), including diffractive element 15, which are, in particular, the diffractive optical element 15 as well as the aspherical surface, have the same data as are given in Example 1 for the object distance of 351 mm.

TABLE 3

| | | Thickness or | Glass or | Free diameter |
|---|---|---|---|---|
| No. | Radius [mm] | air gap [mm] | medium | [mm] |
| 0 | | 501.0 | air | |
| 1-4 | see Table 1 | | | |
| 5 | 395.884236 | 1.3 | Ohara SNPH2 | 24.5 |
| 6 | 73.933988 | 14.975 | air | 24.5 |
| 7 | −21.723776 | 0.8 | Schott | 12.4 |
| | | | NPK52A | |
| 8 | 16.782086 | | air | 12.4 |

Another advantage of the magnifying glasses according to the invention consists of the fact that the two plastic lenses are the same for all working distances (see Tables 1 to 3).

### REFERENCE NUMBERS

10 Optical apparatus (telescope)
11 Optical axis
15 Diffractive optical element
20 Objective element
21 Support lens element for a diffractive optical element
22 Lens surface (Front surface)
23 Support surface for the diffractive optical element
24 Objective lens element
25 Lens surface
26 Lens surface
27 Objective lens element
28 Lens surface
29 Lens surface
30 Ocular or eyepiece element
31 Ocular lens element
32 Lens surface
33 Lens surface
d Groove depth
h Groove width

1. An optical apparatus, in particular, a telescopic apparatus, with at least one objective element which has two or more objective lens elements, wherein one of the objective lens elements is designed as a support lens element for a diffractive optical element, the support lens element having a diffractive optical element, is hereby characterized in that the optical apparatus is designed as a Galileo system or as a Kepler system, that the optical apparatus has an ocular or eyepiece element with at least one ocular lens element, that the diffractive optical element is disposed in the optical apparatus or designed in such a way that the light rays impinge on it at an angle of less than 20 degrees and that the diffractive optical element has a minimum groove width h of greater than 50 μm, in particular, of greater than 100 μm.

2. The optical apparatus according to claim 1, further characterized in that the objective element has three objective lens elements.

3. The optical apparatus according to claim 1, further characterized in that at least one lens surface of at least one objective lens element is formed as an aspherical surface.

4. The optical apparatus according to claim 1, further characterized in that the objective lens element designed as a support lens element for the diffractive optical element and/or at least one objective lens element not designed as a support lens element for the diffractive optical element is/are formed from plastic.

5. The optical apparatus according to claim 1, further characterized in that the diffractive optical element is designed or disposed on the support surface of the support lens element as an annular system.

6. The optical apparatus according to claim 1, further characterized in that the diffractive optical element is designed in a step-shaped manner.

7. The optical apparatus according to claim 1, further characterized in that the diffractive optical element is disposed or designed on a support surface of the support lens element and that the support surface consists of a fundamental spherical shape.

8. The optical apparatus according to 1, further characterized in that the diffractive optical element is disposed inside the objective element.

9. The optical apparatus according to claim 1, further characterized in that at least one ocular lens element is formed from at least two lens elements as a cemented member.

10. The optical apparatus according to claim 1, further characterized in that at least one ocular lens element is designed as a lens element with variable focal length.

11. The optical apparatus according to claim 1, further characterized in that it is designed as a magnifying apparatus or as a binocular apparatus or as a telescopic apparatus or as a liquid lens with a toroidal surface.

12. The use of an optical apparatus according to claim 1 as a magnifying apparatus, in particular, in magnifying glasses, or as a binocular apparatus, or as a telescopic apparatus, or as a liquid lens with a toroidal surface.
